(19) United States
(12) Patent Application Publication
(10) Pub. No.: US 2007/0202752 A1
(43) Pub. Date: Aug. 30, 2007

(54) Electrical socket

(75) Inventors: Andreas Schumann, Steinenbronn (DE); Gerd Philipp, Boeblingen (DE)

Correspondence Address: Lipsitz & McAllister, LLC, 755 MAIN STREET, MONROE, CT, 06468, US

(73) Assignee: Telegaertner Karl Gaertner GmbH, Steinenbronn (DE)

(21) Appl. No.: 11/508,555

(22) Filed: Aug. 22, 2006

(30) Foreign Application Priority Data
Aug. 25, 2005 (DE) 102005041035.9

(51) Int. Cl. H01R 24/00

(52) U.S. Cl. 439/676

(57) ABSTRACT

The invention relates to an electrical socket with a housing, which has a plug compartment for inserting a coupling plug, and with a number of contact springs, which are disposed side by side in a row in the plug compartment, form a row of contact springs and can be contacted by associated plug contacts of the coupling plug, a stop which limits the deflection of the contact springs being associated in each case with the contact springs of the row of contact springs. In order to reduce the risk of damaging a contact spring or a stop, it is proposed according to the invention that the contact springs can be made to butt against the respective stop face-to-face over their entire length and that the stops are connected to one another in one piece and form a stop element, which has in each case between directly neighboring stops a clearance for receiving a retaining rib of the coupling plug disposed between neighboring plug contacts.

The present disclosure relates to the subject matter disclosed in German application number 10 2005 041 035.9 of Aug. 25, 2005, which is incorporated herein by reference in its entirety and for all purposes.

### BACKGROUND OF THE INVENTION

The invention relates to an electrical socket with the features of the preamble of Patent claim 1.

Sockets are known for example from DE 102 42 143 A1 and are also referred to as “Western sockets”. They are used in communication and data technology for establishing electrical connections. The interaction of the socket with a corresponding coupling plug allows a releasable electrical connection to be established for the transmission of electrical signals. In many cases, the socket has eight contact springs disposed side by side. Two contact springs are respectively associated with a pair of conductors, so that electrical signals can be transmitted by means of the socket via four pairs of conductors. However, sockets with only six contact springs are also known, for the transmission of electrical signals via three pairs of conductors. The plug compartment for inserting a coupling plug that is provided in a socket with eight contact springs is wider than the plug compartment that is provided in a socket with only six contact springs. The corresponding coupling plugs have a contact configuration with six or eight plug contacts, which are associated with the respective contact springs of the sockets. On account of the configuration of the plug compartments that are provided in sockets with six or eight contact springs, the user can mistakenly insert a coupling plug that is intended for a socket with six contact springs into a socket with eight contact springs. This may result in the contact springs of the socket being damaged, since they are kept as short as possible to avoid any interfering electrical signal coupling occurring within the socket between pairs of conductors, which could result in an impairment of the transmission quality. If a coupling plug with six plug contacts is inserted into a socket with eight contact springs, there is the risk of at least the outer contact springs of the row of contact springs being plastically deformed by the coupling plug. If the coupling plug having six plug contacts is subsequently replaced by a coupling plug which has eight plug contacts, the plastic deformation of the outer contact springs of the socket may have the result that no electrical connection can be established any longer between the outer contact springs and the associated plug contacts of the coupling plug.

In order to avoid the mistaken insertion of a coupling plug with only six plug contacts (hereafter referred to as “non-compatible coupling plug”) into a socket with eight contact springs, it is proposed in US patent application US 2005/0153580 A1 for a rib or a projection to be disposed under each of the two outer contact springs. When a non-compatible coupling plug is mistakenly inserted, these ribs or projections form a stop against which the outer contact springs butt, so that they cannot be bent any further. If it is attempted to insert a coupling plug with only six plug contacts into the socket, the user feels increasing resistance on account of the outer contact springs not bending any further, making him aware that he is in the process of inserting a non-compatible coupling plug.

In US patent application US 2002/0009930 A1, to avoid improper insertion it is proposed to use a stop element which takes the form of a ramp, is displaceable in the direction of insertion of the coupling plug against an elastic restoring force and is disposed under the row of contact springs. The ramp extends transversely in relation to the contact springs and forms a common stop for all the contact springs.

Although the risk of a non-compatible coupling plug being inserted into the socket can be reduced by using the aforementioned stops and stop elements which restrict the bending movement of the contact springs, an inattentive user may insert the non-compatible coupling plug so far into the plug compartment that at least one contact spring or a stop is damaged before he realizes that he is using an incorrect coupling plug.

It is therefore an object of the present invention to develop an electrical socket of the type mentioned at the beginning in such a way as to reduce the risk of damaging a contact spring or a stop when a non-compatible coupling plug is used.

### SUMMARY OF THE INVENTION

This object is achieved according to the invention in the case of an electrical socket of the generic type by it being possible for the contact springs to be made to butt against the respective stop face-to-face over their entire length and by the stops being connected to one another in one piece and forming a stop element which has in each case between directly neighboring stops a clearance for receiving a retaining rib of the coupling plug disposed between neighboring plug contacts.

The provision of stops for all the contact springs ensures that their respective deflection is limited, so they cannot be bent beyond their deflection, that is to say plastic deformation of the contact springs is ruled out. The contact springs can be made to butt against the respective stop face-to-face over their entire length. This has the advantage that buckling of the contact springs can be reliably avoided. If a coupling plug which has as many plug contacts as there are contact springs is inserted into the plug compartment that is provided in the socket, an electrical connection can be established between all the plug contacts and contact springs. If, however, a non-compatible coupling plug is mistakenly inserted into the plug compartment, a marginal region of a supporting part of the coupling plug carrying the plug contacts comes up against the outer contact springs, which however can only bend to the extent that they butt against the respectively associated stop. Plastic deformation of the contact springs is thereby avoided, and at the same time it is prevented that the non-compatible coupling plug can be inserted completely into the plug compartment. Even if, by being inattentive, the user continues to insert the coupling plug into the plug compartment, all the contact springs are reliably supported and damage to the contact springs is avoided.

The individual stops are connected to one another in one piece and form a stop element, which may for example be produced from a plastics material. The stops consequently represent a common component, which can be inserted into the housing in a simple manner during the assembly of the socket. Between stops that are directly neighboring one another, the stop element has in each case a clearance for receiving a retaining rib of the coupling plug disposed between neighboring plug contacts. The retaining ribs may be connected in one piece with the support part of the coupling plug on which the plug contacts are held. The retaining ribs can be inserted into the clearances between neighboring stops when the coupling plug is inserted into the plug compartment. The coupling plug consequently undergoes mechanical guidance in the region of the stops and the sensitive contact springs are protected from mechanical impairment by the stops and by the retaining ribs disposed next to the contact springs. The one-piece configuration of all the stops in the form of the stop element also has the effect of protecting them from damage. The socket according to the invention is consequently distinguished by a long service life and a high mechanical load-bearing capacity.

In the case of an advantageous embodiment, the stop element is disposed in a cutout in a bottom wall of the plug compartment. Here it is advantageous if the cutout receives the stop element with positive engagement. The bottom wall may be formed for example by an insulating body of the socket, which delimits the plug compartment at the bottom and preferably also at the rear and can be inserted into the housing.

In the case of a preferred embodiment, the alignment and assembly of the stop element is simplified by the bottom wall of the plug compartment covering the stop element in at least a marginal portion. It may for example be provided that the stop element has a sloping surface on each of two sides facing away from each other, which is covered by a corresponding sloping surface of the bottom wall, against which it lies preferably face-to-face.

Particularly good protection from mechanical impairment of the contact springs is achieved in the case of an advantageous embodiment by the stop element reaching around the outer contact springs of the row of contact springs. In the case of such an embodiment, the stop element not only forms stops limiting the respective deflection of the contact springs, but additionally has finger-like extensions, which reach laterally around the outer contact springs.

In the case of a particularly preferred embodiment, the socket comprises a printed circuit board and the contact springs are each connected to a contact pin, which is held in a bore in the printed circuit board, and the stops form in their region facing the contact pin a first, preferably rising ramp, for the abutment of a first portion of the respective contact spring, for example the end region of the respective contact spring that faces the contact pin. Contact springs and contact pins may be respectively connected to one another in one piece and form a contact element which is preferably produced from spring steel. During the assembly of the socket, the contact pin is inserted into a bore in the printed circuit board, for example pressed into it. The printed circuit board has conductors, by means of which the contact pins are in connection with terminal contacts to which the wires of a connecting cable can be connected. The terminal contacts may likewise be held in bores in the printed circuit board, preferably pressed into the bores. The contact springs adjoin the contact pins on the upper side of the printed circuit board and the stops respectively have in their region facing the contact pins a first ramp, against which for example the end region of the contact spring that is facing the contact pin can be made to butt face-to-face. The form of the ramp may correspond to the form of the contact spring. Damage to the contact spring when it butts against the respective stop can be reliably prevented in this way.

It is of particular advantage if the stops form in their region facing away from the contact pin a second, preferably falling ramp, for the abutment of a second portion of the respective contact spring, for example the free end region of the respective contact spring. The free end regions of the contact springs may be bent away in the direction of the bottom wall of the plug compartment, and provision of the second ramp ensures that the free end region of the contact springs can be made to butt against the respective stop face-to-face.

In order to avoid damage to the contact springs in their transitional region with the respective contact pin, it is advantageous if the contact springs lie directly against a stop in this transitional region. In the case of such an embodiment, there is no clearance between the transitional region of the contact springs and the associated stop, but instead the stop extends up to the transitional region.

It is of particular advantage here if the stops are arcuately curved in their end region facing the transitional region. The arcuately curved end region may be adjoined by the first ramp.

The following description of two preferred embodiments of the invention serves in conjunction with the drawing for a more detailed explanation.

### BRIEF DESCRIPTION OF THE DRAWINGS

FIG. 1 shows a graphic representation in the manner of an exploded drawing of a first embodiment of an electrical socket according to the invention;

FIG. 2 shows an enlarged representation of detail A from FIG. 1;

FIG. 3 shows a graphic representation of a stop element of the electrical socket from FIG. 1;

FIG. 4 shows a longitudinal sectional view of the electrical socket from FIG. 1 with a coupling plug inserted into the plug compartment that is provided in the socket;

FIG. 5 shows an enlarged representation of the contact region of the socket from FIG. 1 corresponding to detail B from FIG. 4;

FIG. 6 shows a graphic representation in the manner of an exploded drawing of a second embodiment of an electrical socket according to the invention;

FIG. 7 shows an enlarged representation of detail C from FIG. 6;

FIG. 8 shows a graphic representation of a stop element of the electrical socket from FIG. 6;

FIG. 9 shows a side view of the stop element from FIG. 8 and

FIG. 10 shows an enlarged representation of the contact region of the socket from FIG. 6.

### DETAILED DESCRIPTION OF THE INVENTION

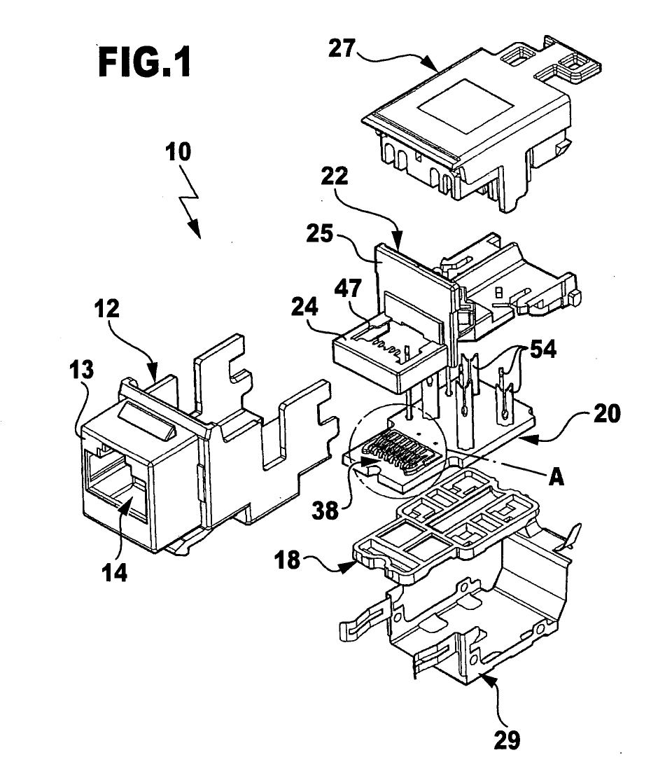

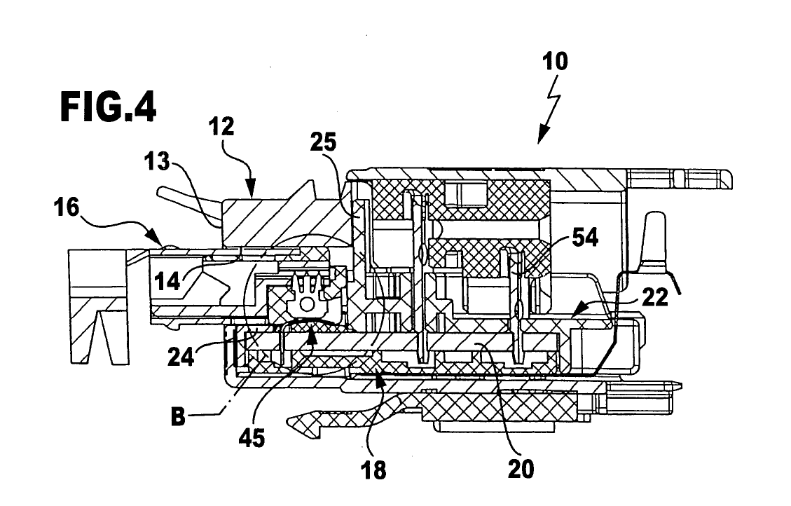

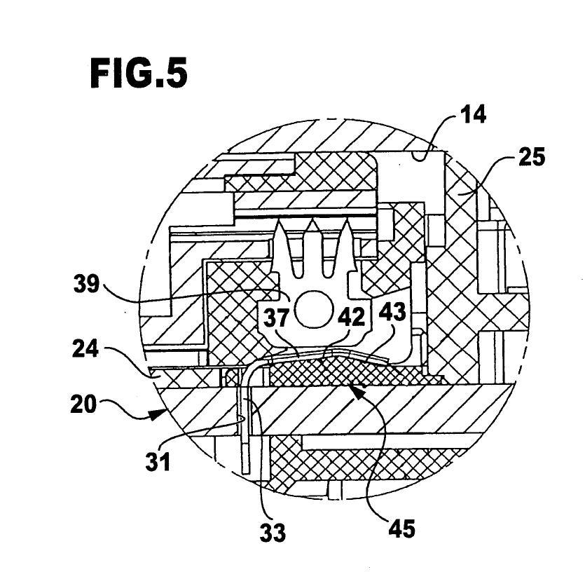

In FIGS. 1 to 5, a first embodiment of an electrical socket 10 accoring to the invention is schematically represented. It comprises a housing 12, which has a front side 13, into which there opens a plug se, which is schematically represented in FIG. 4.

On the underside, an insulating plate 18 may be inserted into the housing, which plate carries a printed circuit board 20, on which an insulating body 22 can be placed. The insulating body 22 forms a bottom wall 24 and a rear wall 25, which delimit the plug compartment 14 at the bottom and at the rear.

A cover 27 may be placed on the housing 12, and on the underside and at the rear the housing 12 may be adjoined by a shielding plate 29 for the electrical shielding of the socket 10.

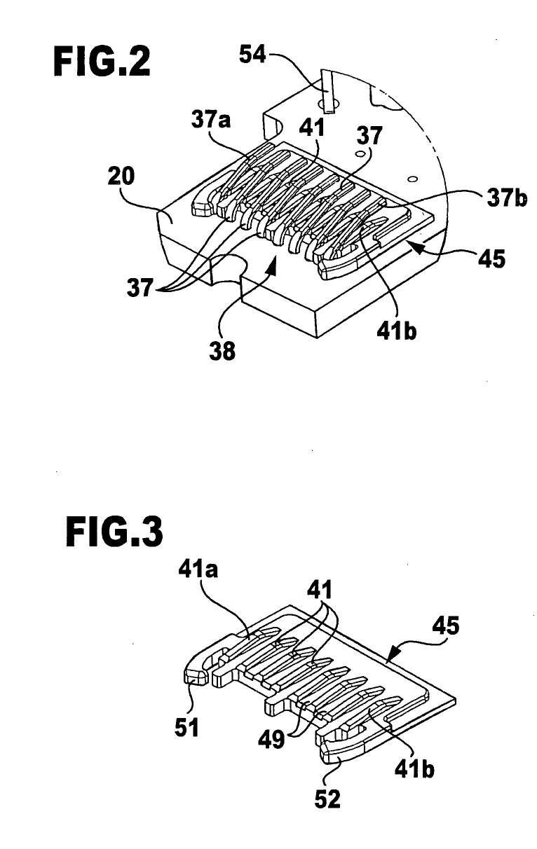

The printed circuit board 20 has a row of through-bores 31. Pressed into the through-bores 31 is in each case a contact pin 33, which is adjoined in one piece on the upper side 35 of the printed circuit board 20 by a contact spring 37. Altogether, the socket 10 represented in the drawing has eight contact springs 37 disposed side by side in a row, which form a row 38 of contact springs, protrude beyond the printed circuit board 20 and enter the plug compartment 14. The outer contact springs of the row 38 of contact springs are respectively provided with the reference numerals 37a and 37b in FIG. 2. If a coupling plug 16 is inserted into the plug compartment 14, a plug contact 39 of the coupling plug 16 can in each case contact a contact spring 37 to establish an electrical connection between the socket 10 and the coupling plug 16.

If the coupling plug 16 is inserted into the plug compartment 14, the contact springs 37 of the associated plug contacts 39 are elastically deformed. However, the contact springs 37 can only be deformed to a limited extent, since under each contact spring 37 there is a stop 41, which forms a rising ramp 42, facing the contact pin 33, and a falling ramp 43, facing away from the contact pin 33. All the stops 41 are connected to one another in one piece and in their entirety form a stop element 45, which is accommodated by a cutout 47 in the bottom wall 24 of the insulating body 22. The cutout 47 is formed as a through-opening, into which the stop element 45 can be inserted from below. All the stops 41 of the stop element 45 are disposed side by side in a row. The stops lying on the outside in the row of stops 41 are respectively provided with the reference numerals 41a and 41b in FIG. 3.

Between directly neighboring stops 41, the stop element 45 has in each case a clearance 49. Retaining ribs (not represented in the drawing) of the coupling plug 16, which are disposed between neighboring plug contacts 39, can enter the clearances 49.

The stops 41 protrude slightly beyond the bottom wall 24 into the interior of the plug compartment 14. It may be provided, for example, that the stops 41 protrude beyond the bottom wall 24 by at most 0.5 mm, preferably less than 0.4 mm, in particular about 0.3 to 0.4 mm.

The stops 41a and 41b lying on the outside in the row of stops 41 are laterally embraced by fingers 51 and 52 of the stop element 45 and are therefore protected particularly effectively from mechanical impairment.

The printed circuit board 20 has in the customary way conductors by means of which the contact pins 33 are in electrical connection with terminal contacts 54, which are likewise pressed into the printed circuit board 20 and to which the wires of a connecting cable known per se, and therefore not represented in the drawing, can be connected.

If a coupling plug 16 is inserted into the plug compartment 14, plastic deformation of the contact springs 37 is reliably prevented by the stops 41. The risk of such deformation exists in particular if a coupling plug which has only six plug contacts, adjoined on each outer side by a rigid side region of the coupling plug, is inserted into the plug compartment 14. If such a coupling plug 16, that is to say an incompatible coupling plug, is inserted into the plug compartment 14, the rigid lateral regions of the coupling plug 16 come up against the outer contact springs 37a, 37b. Since, however, they are limited in their deflection by the outer stops 41a and 41b, plastic deformation, in particular of the contact springs 37a, 37b, can be reliably prevented.

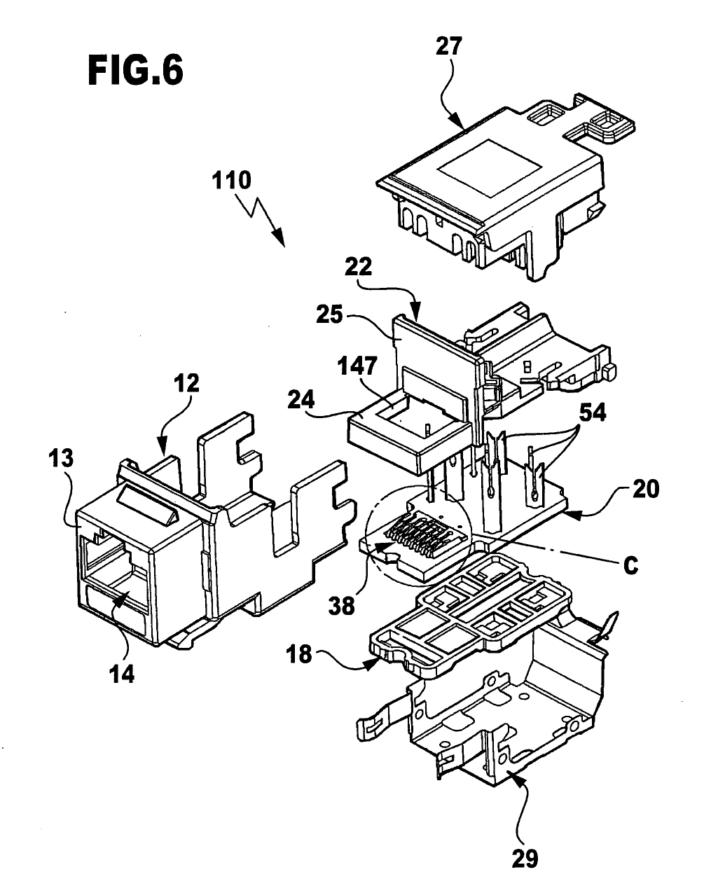

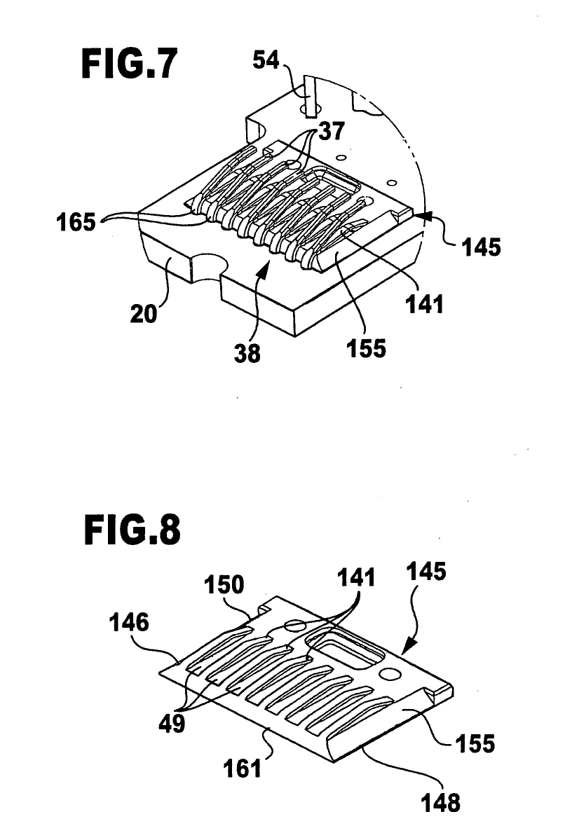

In FIGS. 6 to 10, a second embodiment of a socket according to the invention is represented, provided overall with the reference numeral 110. This is formed largely identically to the socket 10 illustrated in FIGS. 1 to 5. Therefore, the same reference numerals as in FIGS. 1 to 5 are used in FIGS. 6 to 10 for identical components and, to avoid repetition, reference is made to the foregoing explanations with respect to these components.

The socket 110 differs from the socket 10 in that it uses a stop element 145, which is of a substantially rectangular form in plan view and, as a difference from the stop element 45, does not have any laterally protruding fingers. By contrast with the stop element 45, it has on transverse sides 146, 148 facing away from each other in each case a sloping surface 150 and 155, respectively, which are covered by corresponding sloping surfaces of the cutout 147, formed as a through-opening, in the bottom wall 24 of the insulating body 22. The stop element 145 can be inserted into the cutout 147 from below and is aligned by the sloping surfaces 150, 155 and the corresponding sloping surfaces of the cutout 147 in a simple manner.

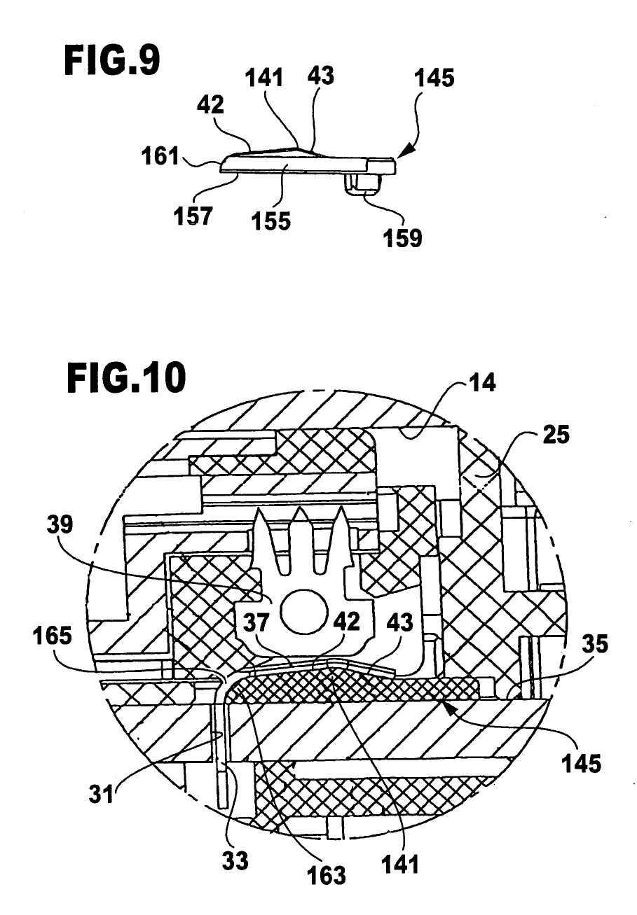

From the underside 157 of the stop element 145, two protuberances protrude downward, only one protuberance 159 being shown in FIG. 9. The protuberances 159 can be inserted into a corresponding bore in the printed circuit board 20 of the socket 110. This makes simple alignment of the stop element 145 with respect to the printed circuit board 20 possible.

On the upper side, the stop element 145 comprises eight stops 141, which are disposed laterally side by side and respectively extend to a cross-sectionally arcuately curved longitudinal side 161 of the stop element 145, so that an end region 163 of the stops 141 disposed on the longitudinal side 161 is likewise arcuately curved. The end region 163 is adjoined by the rising ramp 42 and this in turn is adjoined by the falling ramp 43, as already explained in conjunction with the stops 41 of the socket 10.

As becomes clear from FIG. 10, the stop element 145 extends with its longitudinal side 161 up to the level of the through-bores 31 in the printed circuit board 20. As a result, a transitional region 165 of the contact springs 37, which adjoins the respective contact pin 33 on the upper side of the printed circuit board 20, can lie directly against the end region 163 of the respective stop 141. The contact springs 37 of the socket 110 can consequently be made to butt against the respectively associated stop 141 face-to-face over their entire length when a corresponding coupling plug 16 is inserted into the plug compartment 14 that is provided in the socket 110, as illustrated in FIG. 10.

For assembly, the stop element 145 may be initially aligned in relation to the printed circuit board 20 by means of the protuberances 159. Subsequently, the stop element 145 may be adhesively bonded to the printed circuit board 20, preferably by means of ultrasound, and, in a subsequent assembly step, the printed circuit board 20 can then be positioned together with the stop element 145 on the underside of the bottom wall 24, the stop element 145 entering the cutout 147 from below and the stops 141 projecting about 0.3 mm beyond the upper side of the bottom wall 24.

Also in the case of the socket 110, plastic deformation of the contact springs 37 is reliably prevented by the stops 141, as already explained in detail above with reference to the socket 10.

1. Electrical socket with a housing, which has a plug compartment for inserting a coupling plug, and with a number of contact springs, which are disposed side by side in a row in the plug compartment, form a row of contact springs and can be contacted by associated plug contacts of the coupling plug, a stop which limits the deflection of the contact springs being associated in each case with the contact springs of the row of contact springs, wherein the contact springs can be made to butt against the respective stop face-to-face over their entire length and the stops are connected to one another in one piece and form a stop element, the stop element having in each case between directly neighboring stops a clearance for receiving a retaining rib of the coupling plug disposed between neighboring plug contacts.

2. Electrical socket according to claim 1, wherein the stop element is disposed in a cutout in a bottom wall of the plug compartment.

3. Electrical socket according to claim 2, wherein the cutout receives the stop element with positive engagement.

4. Electrical socket according to claim 2, wherein the bottom wall covers the stop element in at least a marginal portion.

5. Electrical socket according to claim 1, wherein the socket has a printed circuit board and the contact springs are each connected to a contact pin, which is held in a bore in the printed circuit board, and the stops form in their region facing the contact pin a first ramp, for the abutment of a first portion of the respective contact spring.

6. Electrical socket according to claim 5, wherein the stops form in their region facing away from the contact pin a second ramp, for the abutment of a second portion of the respective contact spring.

7. Electrical socket according to claim 5, wherein, in their transitional region with respect to the respective contact pin, the contact springs lie directly against a stop.

8. Electrical socket according to claim 7, wherein the stops are arcuately curved in their end region facing the transitional region.
